(19) United States
(12) Patent Application Publication
(10) Pub. No.: US 2004/0205666 A1
(43) Pub. Date: Oct. 14, 2004

(54) System and method for anticipated file editing

(76) Inventor: Todd Allan Poynor, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/972,681

(22) Filed: Oct. 5, 2001

(51) Int. Cl. G06F 15/00

(52) U.S. Cl. 715/531

(57) ABSTRACT

The present invention is a system and method for editing a file. Within the method of the present invention: an edit region is designated within the file; an initial edit is effected on an original character string within the designated edit region; a record of the initial edit and the edit region in which the initial edit is made is saved in memory; subsequent instances of the original character string are identified only within the edit region; and suggested edits to the subsequent instances of the original character string are derived from the initial edit retrieved from the memory. The system of the present invention includes: a means for designating an edit region within the file; a means for effecting an initial edit on an original character string within the designated edit region; and a means for identifying subsequent instances of the original character string only within the edit region.

### BACKGROUND OF THE INVENTION

1. Field of the Invention

The present invention relates generally to systems and methods for file editing, and more particularly to anticipating edits within a file.

2. Discussion of Background Art

When creating or editing files, including computer programs, text documents, as well as many others, portions of such files are often cut and pasted, or copied and pasted to a variety of different locations within a single file or between multiple files. For example, when editing a text document, it is common to create new text based on portions of pre-existing text, perhaps obtained from elsewhere in the same document or from a different document. Such creation and editing often requires that characters within these pasted portions be modified in order to tailor the portions to their new context. And, even though such modifications may be extensive, they still enable authors to leverage pre-existing work spent on, for example, gathering certain types of information (e.g. name, phone number, and e-mail address), formatting, complying with programming syntax rules, and/or coding similar algorithms.

A significant danger of using such copy, paste and modification techniques is an exposure to characters, words, program commands, variables, and etc. which, although appropriate in the cut or copied portion's previous context, are not appropriate within the context into which the portion is pasted. For example, during computer programming, it is not uncommon to identify “cut-and-paste” or “copy-and-paste” bugs which cause the program to fail due to internal references to incorrect variables or function names originating from portions of code copied from other instances of similar code.

Identifying such bugs can be particularly difficult since the incorrect variables or function names may be valid in both their old and new contexts (e.g. global variable names or text copied within the same function scope). Such bugs may not even be identified as source code compilation errors, or may only yield compilation warnings, which often go ignored.

In response to the concerns discussed above, what is needed is a system and method for file editing that overcomes the problems of the prior art.

### SUMMARY OF THE INVENTION

The present invention is a system and method for editing a file. Within the method of the present invention: an edit region is designated within the file; an initial edit is effected on an original character string within the designated edit region; a record of the initial edit and the edit region in which the initial edit is made is saved in memory; subsequent instances of the original character string are identified only within the edit region; and suggested edits to the subsequent instances of the original character string are derived from the initial edit retrieved from the memory.

The system of the present invention includes: a means for designating an edit region within the file; a means for effecting an initial edit on an original character string within the designated edit region; and a means for identifying subsequent instances of the original character string only within the edit region.

These and other aspects of the invention will be recognized by those skilled in the art upon review of the detailed description, drawings, and claims set forth below.

### BRIEF DESCRIPTION OF THE DRAWINGS

FIG. 1 is a pictorial diagram of a file having a designated edit region;

FIG. 2 is a flowchart of a method for editing a file having a designated edit region;

FIG. 3 is a pictorial diagram of an initial edit operation within the designated edit region;

FIG. 4 is a pictorial diagram of subsequent instances of original characters within the designated edit region; and

FIG. 5 is a pictorial diagram of suggested edits to the designated edit region.

### DETAILED DESCRIPTION OF THE PREFERRED EMBODIMENT

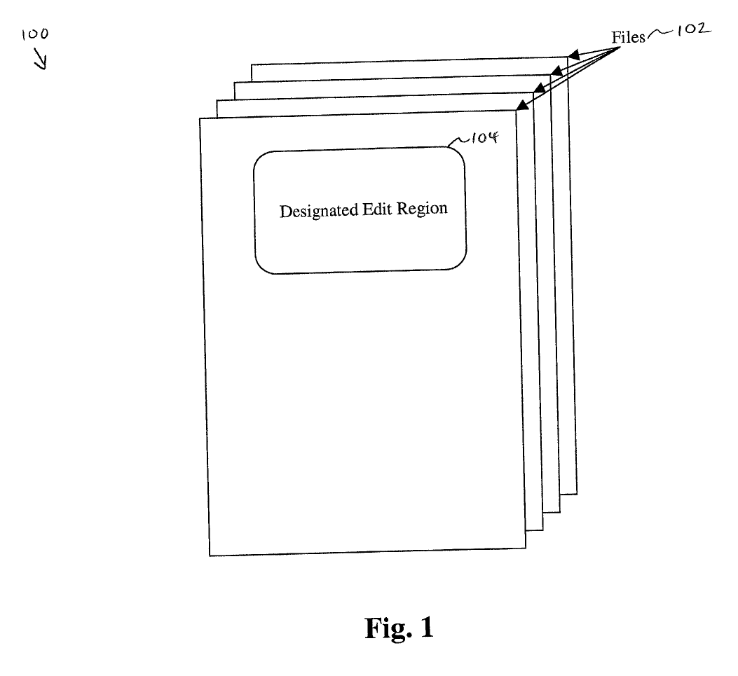

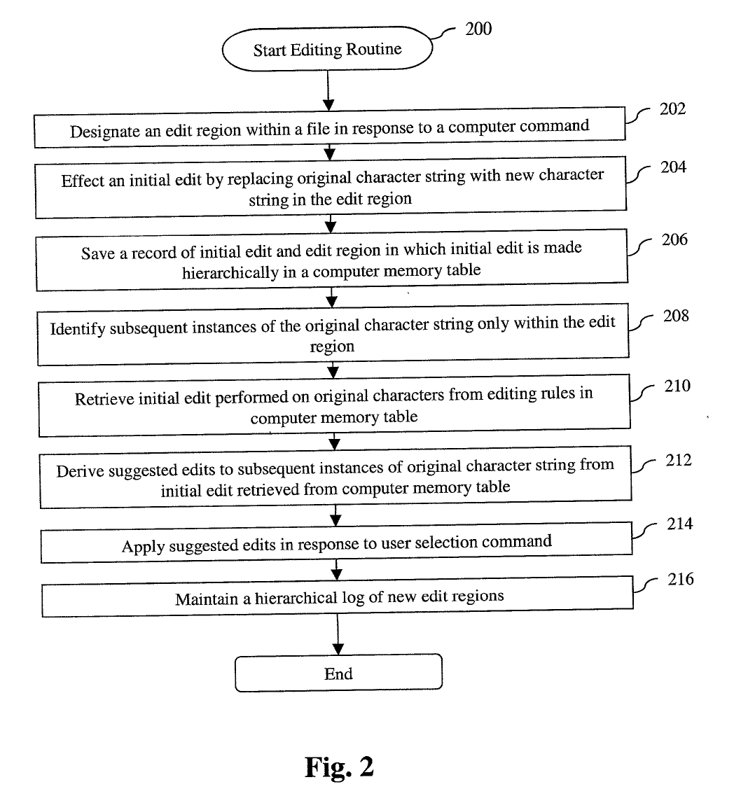

FIG. 1 is a pictorial diagram 100 of several files 102 at least one of which has a designated edit region 104. FIG. 2 is a flowchart 200 of a method 200 for editing a file having a designated edit region. Both the system and method are now discussed together and are preferably implemented within a computer system (not shown). For the purposes of the present invention the files 102 can be of any type, including .dat, .txt, .exe, .dir, and other known file formats. The present invention, however, is not limited to these file types, and may be equally applied to other currently existing and any future developed file types.

The files 102 include sets of characters. For the purposes of the present invention these characters can represent information of any type, including letters of the alphabet, numbers, punctuation symbols, command strings and/or many others known to those skilled in the art.

The method 200 begins in step 202 where an edit region is designated within one of the files 102 in response to a computer command sequence. The commands may include user selection commands, paste commands, cut and paste commands, and copy and paste commands. If the edit region is designated by one of the paste commands, the present invention automatically defines the edit region 104 as a region initially containing only a pasted set of characters. Alternatively, a user may link together several different edit regions distributed throughout any of the files 102.

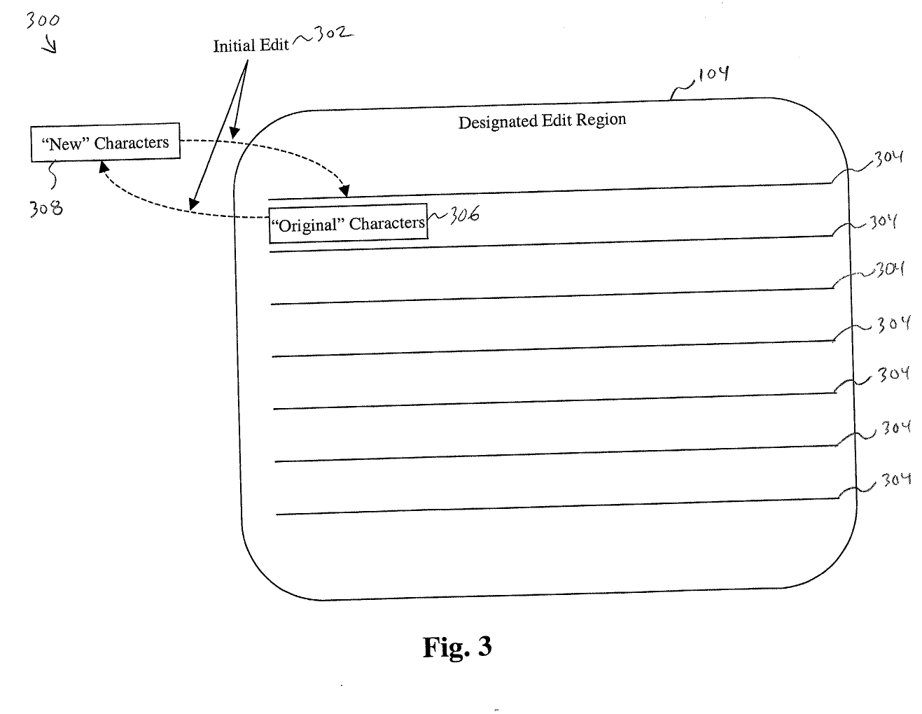

FIG. 3 is a pictorial diagram 300 of an initial edit operation 302 within the designated edit region 104. The edit region 104, in this example, has a series of lines 304 containing an original set of characters 306. In step 204, the initial edit 302 is effected by replacing the original character string 306 with a new character string 308. The initial edit 302 preferably is made in response to standard editing commands including inserting new characters, deleting existing characters, and overwriting characters, as well as other well known editing techniques.

In step 206, a record of the initial edit operation 302 and the edit region 104 in which the initial edit 302 is made are both saved in a computer memory table as a hierarchical set of editing rules. The saving operation in step 206 can either occur after a waiting period or in real time. If the waiting period is used, the saving step 206 can be postponed until the initial edit 302 is complete. Completion of the initial edit 302 can be defined in any number of ways, such as when a user moves a computer cursor outside of the edit region 104; after a period of user editing activity; or based on various language or context specific rules appropriate to the type of file being edited. Alternatively, the initial edit 302 may be saved real-time as the user edits the original character string 306.

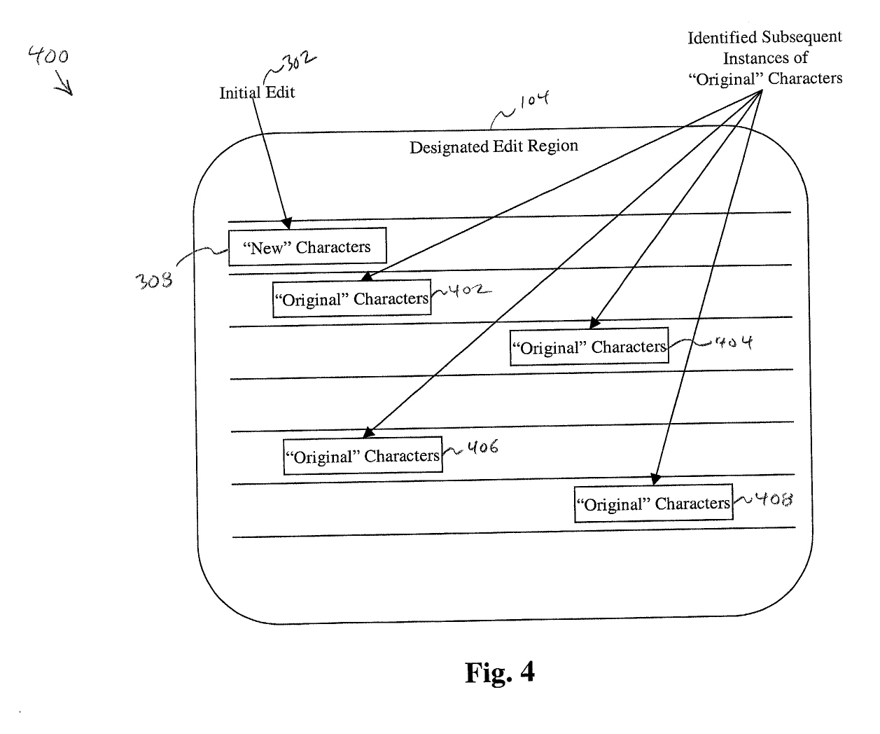

FIG. 4 is a pictorial diagram 400 of subsequent instances 402-408 of the original character string 306 within the designated edit region 104. In step 208, the subsequent instances 402-408 of the original character string 306 are identified only within the edit region 104. These subsequent instances 402-408 can be duplicate instances of text or further references to a same “program language construct” within the original character string 302. Identification of these subsequent instances can include: temporarily modifying a displayed color or other video characteristics of the subsequent instances; displaying a list or count of the subsequent instances; or by generating alerts of some other nature.

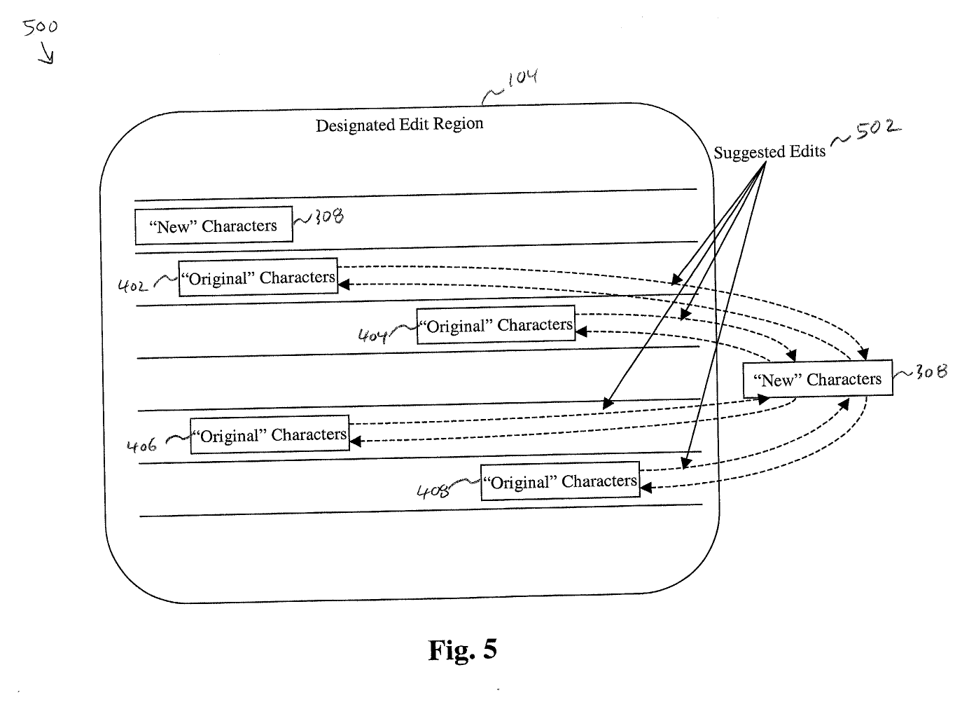

FIG. 5 is a pictorial diagram 500 of suggested edits 502 to the designated edit region 104. In step 210, the initial edit 302 performed on the original characters 306 is retrieved from the editing rules in the computer memory table. In step 212, the suggested edits 502 to the subsequent instances 402-408 of the original character string 306 are then derived from the initial edit 302 retrieved from the table. In step 214, at the user's discretion, all of the suggested edits 502 can either be automatically made, or made to only a subset of the subsequent instances 402-408 in response to a user selection command.

In step 216, a hierarchical log of all edit regions designated within any of the files 102 by the user is maintained. The hierarchical log enables the user to edit different edit regions in any order while ensuring that suggested edits continue to be made regardless of the order the edit regions are modified.

According to the teaching above, the present invention enhances text editing, word processing, computer programming, and many other computer based editing tasks. By differentiating edits made within the edit region 104 from edits elsewhere in a file, and by suggesting edits only upon that region, the present invention adds significant value over current state of the art existing editor operations, which can only search and replace text upon an entire file, or which can not automatically designate edit region or anticipate user editing operations.

The present invention in fact teaches how the edit region 104 can be automatically designated in response to either cut-paste or copy-paste editing operations. The present invention then automatically suggests additional edits within the edit region 104, thus not requiring a user to identify and implement such modifications manually. Furthermore, the present invention enables the user to have the suggested edits implemented automatically every time the user makes a modification within the edit region 104.

While the present invention has been described above with reference to word processing of text files, those skilled in the art recognize that the same techniques may be also applied to program source code files, software language files, as well as many other types of files. For example, in response to modifications to variables in a program source code file, the system alerts the user to other occurrences of the same variable name within the edit region. Or, in response to modifications to program variable types in a software language file, such as by converting the variable type from type “pointer to integer” to type “integer,” the system can suggest language-specific transformations referencing the variable, and offer to apply such transformations to the “each instance of the variable” in the edit region.

While one or more embodiments of the present invention have been described, those skilled in the art will recognize that various modifications may be made. Variations upon and modifications to these embodiments are provided by the present invention, which is limited only by the following claims.

What is claimed is:

1. A method for editing a file, comprising the steps of:
designating an edit region within the file;
effecting an initial edit on an original character string within the designated edit region; and
identifying subsequent instances of the original character string only within the edit region.

2. The method of claim 1 wherein the designating step includes the steps of:
pasting a set of characters into the file; and
defining the edit region as only the pasted set of characters, in response to the pasting step.

3. The method of claim 2 wherein the designating step includes the step of:
cutting the set of characters from another location before pasting.

4. The method of claim 2 wherein the designating step includes the step of:
copying the set of characters from another location before pasting.

5. The method of claim 1, wherein the effecting step includes the step of:
replacing the original character string with a new character string.

6. The method of claim 1 wherein the identifying step includes the step of:
modifying a displayed color of the subsequent instances of the original character string.

7. The method of claim 1 wherein the identifying step includes the step of:
displaying a list of the subsequent instances of the original character string.

8. The method of claim 1 further comprising the step of:
automatically applying the initial edit to the subsequent instances of the original character string.

9. The method of claim 1 wherein the suggesting step includes the step of:
prompting a user to decide whether to apply the initial edit to the subsequent instances of the original character string.

10. The method of claim 1 wherein:
the designating step includes the step of designating the edit region within a source code file; and
the effecting step includes the step of effecting an initial edit on a variable within the designated edit region.

11. The method of claim 1 wherein:
the designating step includes the step of designating the edit region within a source code file; and
the effecting step includes the step of effecting an initial edit on a function name within the designated edit region.

12. The method of claim 1 wherein:
the designating step includes the step of designating the edit region within a source code file; and
the effecting step includes the step of effecting an initial edit on a method of access to a variable function within the designated edit region.

13. The method of claim 1 wherein the designating step includes the step of:
designating the edit region within a text file.

14. The method of claim 1 further comprising the step of:
saving a record of the initial edit and the edit region in which the initial edit is made hierarchically in a computer memory table.

15. The method of claim 14 further comprising the step of:
retrieving the initial edit performed on the original characters from the computer memory table.

16. The method of claim 15 further comprising the step of:
deriving suggested edits to the subsequent instances of the original character string from the initial edit retrieved from the computer memory table.

17. The method of claim 1 further comprising the step of:
maintaining a hierarchical log of edit regions.

18. A method for editing a file, comprising the steps of:
designating an edit region within the file;
effecting an initial edit on an original character string within the designated edit region;
identifying subsequent instances of the original character string only within the edit region;
saving a record of the initial edit and the edit region in which the initial edit is made hierarchically in a computer memory table;
retrieving the initial edit performed on the original characters from the computer memory table;
deriving suggested edits to the subsequent instances of the original character string from the initial edit retrieved from the computer memory table; and
maintaining a hierarchical log of edit regions.

19. A computer-usable medium embodying computer program code for commanding a computer to edit a file, comprising the steps of:
designating an edit region within the file;
effecting an initial edit on an original character string within the designated edit region; and
identifying subsequent instances of the original character string only within the edit region.

20. The medium of claim 19 wherein the designating step includes the steps of:
pasting a set of characters into the file; and
designating the pasted set of characters as the edit region.

21. The medium of claim 19 wherein the suggesting step includes the step of:
applying the initial edit to the subsequent instances of the original character string.

22. The medium of claim 19 further comprising the steps of:
saving a record of the initial edit and the edit region in which the initial edit is made hierarchically in a computer memory table;
retrieving the initial edit performed on the original characters from the computer memory table; and
deriving suggested edits to the subsequent instances of the original character string from the initial edit retrieved from the computer memory table.

23. The medium of claim 19 further comprising the step of:
maintaining a hierarchical log of edit regions.

24. A system for editing a file, comprising:
means for designating an edit region within the file;
means for effecting an initial edit on an original character string within the designated edit region; and
means for identifying subsequent instances of the original character string only within the edit region.

25. The system of claim 24 wherein the means for suggesting includes:
means for applying the initial edit to the subsequent instances of the original character string.

26. The system of claim 24 further comprising:
means for saving a record of the initial edit and the edit region in which the initial edit is made hierarchically in a computer memory table;
means for retrieving the initial edit performed on the original characters from the computer memory table; and
means for deriving suggested edits to the subsequent instances of the original character string from the initial edit retrieved from the computer memory table.

27. The system of claim 24 further comprising:
means for maintaining a hierarchical log of edit regions.
